(19) United States
(12) Patent Application Publication
(10) Pub. No.: US 2023/0347342 A1
(43) Pub. Date: Nov. 2, 2023

(54) MICROFLUIDIC DEVICE AND METHOD FOR ISOLATING OBJECTS

(71) Applicant: Albert-Ludwigs-Universität Freiburg, Freiburg (DE)

(72) Inventor: Peter KOLTAY, Freiburg (DE)

(21) Appl. No.: 18/337,504

(22) Filed: Jun. 20, 2023

Related U.S. Application Data
(63) Continuation of application No. PCT/EP2021/086539, filed on Dec. 17, 2021.

(30) Foreign Application Priority Data
Dec. 22, 2020 (EP) 20216379.6

(51) Int. Cl. B01L 3/00

(52) U.S. Cl. CPC B01L 3/502715; B01L 3/502761

(57) ABSTRACT

A microfluidic device for isolation objects from a liquid suspension comprises at least one fluid inlet and at least one fluid outlet, at least one fluid channel fluidically connecting the at least one fluid inlet to the at least one fluid outlet, a plurality of passive hydrodynamic trapping sites arranged along the at least one fluid channel, each trapping site configured to trap a defined number of objects from a liquid suspension flowing along the at least one fluid channel, and a plurality of nozzle channels, wherein each nozzle channel is in fluidic communication with one of the trapping sites and fluidically connects this trapping site with an associated nozzle orifice. A force may be applied concurrently to the trapped objects and the liquid columns in the nozzle channels so that a liquid aliquot containing the defined number of objects is ejected from each nozzle orifice.

### CROSS-REFERENCE TO RELATED APPLICATIONS

This application is a continuation of copending International Application No. PCT/EP2021/086539, filed Dec. 17, 2021, which is incorporated herein by reference in its entirety, and additionally claims priority from European Application No. EP 20216379.6, filed Dec. 22, 2020, which is also incorporated herein by reference in its entirety.

The present disclosure relates to microfluidic devices and methods for isolating objects such as single cells, particles, spheroids or organoids suspended in a liquid suspension. In particular, the present disclosure relates to microfluidic devices and methods which permit transfer of the isolated objects to receptacles in a parallelized manner.

### BACKGROUND OF THE INVENTION

Single cell isolation, sorting and handling is becoming increasingly important in the field of single-cell analysis. There are several approaches in conventional technology dealing with microfluidic systems for isolating, sorting and handling of cells, cell clusters and particles. For example, [1] provides an extensive overview and systematic categorization with respect to single cell/particle handling. [2] present a comprehensive review of the state of the art in microfluidic isolation technologies for cells/particles. Similar technologies are also available for larger biological particles, such as spheroids. CA 2 805 909 A1 discloses a highly parallel solution for single spheroid culture by a hanging drop method. [3] presents a method for controlled assembly of spheroids from cell suspensions and their subsequent transfer to a micro-well plate (MWP). [4] describes a miniaturized version of the hanging drop method as well as a printing technology for transferring single spheroids from a suspension into a receptacle. [5] presents a method for single spheroid deposition specifically for 3D-bioprinting applications. [6] discloses micro well trapping and DNA (deoxyribonucleic acid) damage analysis using microwell arrays. [7] disclose a single-cell isolation by a modular single-cell pipette for RNA (ribonucleic acid) sequencing. [8] teaches cell separations using affinity methods.

[9] discloses inverted open microwells for cell trapping, cell aggregate formation and parallel recovery of live cells. A substrate comprises microwells, wherein upper ends of the microwells are connected by a fluid channel and lower ends of the microwells are open. Dielectrophoresis is used during delivery of a cell suspension to control cell access to the microwells and force the formation of cell aggregates so as to ensure cell-cell contact and interaction. Cells are trapped at the air-fluid interface at the bottom edge of the open microwells and are analyzed by a microscope. After analysis, live cells are recovered from multiple microwells onto multiple wells of a standard microtiter plate by blowing air through the fluid channel.

A detailed analysis of the state of the art reveals that cells, particles, spheroids or tumoroids suspended in liquid can be isolated by a number of different approaches. Such technologies are in principle applicable to all of these entities regardless of their size and nature.

For simplification, in the following only the term “object” or “cell” will be used to make reference to the object under consideration. The term “object” or “cell” should imply any kind of solid or soft object suspended in liquid, regardless of its size (as long as it may be handled using the microfluidic devices disclosed herein) or whether it is of biological nature or not.

Despite the large variety of available approaches for handling of single cells to place them in a controlled manner into receptacles, current technologies do suffer from at least one or even several of different shortcomings, such as low cell viability, limited throughput, low single-cell efficiency, and closed systems that do not allow for transfer of cells after isolation to other receptacles (e.g., into a MWP).

Another disadvantage of available technologies is the requirement for costly laboratory equipment to process the cells suspended in the liquid, such as fluorescence-activated cell sorting systems, pipetting robots, single-cell printers, and similar instruments.

Therefore, improved methods would be helpful that provide single cell handling in terms of simple manual as well as automatic operation, low cost, high cell viability, high throughput and high single-cell efficiency.

### SUMMARY

According to an embodiment, a microfluidic device may have: at least one fluid inlet and at least one fluid outlet; at least one fluid channel fluidically connecting the at least one fluid inlet to the at least one fluid outlet; a plurality of passive microfluidic trapping sites arranged along the at least one fluid channel, each passive microfluidic trapping site configured to trap a defined number of objects from a liquid suspension flowing along the at least one fluid channel; each trapping site including a nozzle channel in fluidic communication with an associated nozzle orifice.

According to another embodiment, a method for operating an inventive microfluidic device may have the steps of: effecting a flow of a liquid suspension that contains the objects from the at least one fluid inlet through the at least one fluid channel, whereby the trapping sites are occupied by the defined number of objects and liquid columns are formed in the nozzle channels; placing the microfluidic device on a receptacle plate including a plurality of receptacles so that the nozzle orifices mate with the receptacles; and concurrently applying a force to the trapped objects and the liquid columns in the nozzle channels so that a liquid aliquot containing the defined number of objects is ejected from each nozzle orifice.

Examples of the present disclosure provide a microfluidic device comprising at least one fluid inlet and at least one fluid outlet, at least one fluid channel fluidically connecting the at least one fluid inlet to the at least one fluid outlet, and a plurality of passive microfluidic trapping sites arranged along the at least one fluid channel, and a nozzle channel associated with each trapping site. The passive microfluidic trapping sites are configured to trap a defined number of objects from a liquid suspension flowing along the at least one fluid channel. Each of the nozzle channels is in fluidic communication with an associated nozzle orifice.

Examples of the present disclosure provide a method for operating such a microfluidic device. The method comprises effecting a flow of a liquid suspension that contains the objects from the at least one inlet through the at least one fluid channel, whereby the trapping sites are occupied by the defined number of objects and liquid columns are formed in the nozzle channels. The method further comprises placing the microfluidic device on a receptacle plate comprising a plurality of receptacles so that each nozzle orifice mates with one of the receptacles, and concurrently applying a force to the trapped objects and the liquid columns in the nozzle channels so that a liquid aliquot containing the defined number of objects is ejected from each nozzle orifice.

Thus, examples of the present disclosure are based on the finding that a multitude of passive microfluidic trapping sites may be used to isolate a defined number of objects, such as a cell, a cell cluster like a spheroid or an organoid, or particles, from each other in preparation of concurrently transferring the isolated objects into individual receptacles. Making use of microfluidic trapping sites permits a large number of trapping sites to be arranged in the microfluidic device. Since the microfluidic trapping sites are configured to trap the defined number of objects, such as a single cell, trapping need neither to be monitored nor controlled separately. Since each trapping site comprises an associated nozzle channel the trapped objects may be transferred into the individual receptacles through the nozzle channels. Due to the arrangement of the nozzle channels and the actuation force perpendicular to the fluid channel, the trapped object is discharged from the nozzle together with only a small liquid volume contained in the nozzle. Thus, the present disclosure permits a highly parallel isolation of objects and a highly parallel transfer of the objects into individual receptacles without any further active intervention, sensing or control mechanism.

In examples, the microfluidic device may comprise a plurality of fluid channels arranged in parallel to each other, wherein a plurality of microfluidic trapping sites with associated nozzle channels is arranged along each fluid channel, wherein the plurality of nozzle orifices is arranged in a two-dimensional array, the two-dimensional array advantageously corresponding to the arrangement of wells of a micro-well plate. The microfluidic device may be adapted to be placed as a lid on a micro-well plate or may include a holder adapted to hold a micro-well plate. Thus, examples of the present disclosure permit isolated objects to be transferred to the receptacles of a micro-well plate in a parallel and easy manner.

In examples, the microfluidic device comprises a removable seal covering the nozzle orifices such that leakage of liquid suspension during isolation of the objects can be avoided. In examples, the fluid outlet leads into a waste reservoir formed in the microfluidic device such that excess liquid suspension may be accommodated by the microfluidic device.

In examples, the microfluidic device comprises a microfluidic chip having opposing first and second main surfaces, wherein the at least one fluid channel extends parallel to the first and second main surfaces, wherein the nozzle channel extends perpendicular to the at least one fluid channel, and, advantageously, perpendicular to the first and second main surfaces. In such examples, a fluidic acceleration may be generated essentially perpendicular to the at least one fluid channel connecting the individual trapping sites and essentially parallel to the nozzle channels to eject a free flying droplet containing the object from each nozzle orifice.

In examples, the microfluidic device comprises a force applicator configured to apply a force to objects trapped in the passive microfluidic trapping sites and liquid columns in the nozzle channels so as to eject liquid droplets containing the objects through the nozzle orifices. In examples, the force applicator is configured to apply the force such that a liquid acceleration in a direction parallel to the nozzle channels is generated in each nozzle channel. In examples, the force applicator is configured to apply the force to the objects and liquid columns in a parallel manner, i.e., to provide an actuation pulse to all trapping sites and nozzle channels simultaneously and at the same level. In examples, the force applicator comprises a centrifuge configured to apply a centrifugal force to the objects and the liquid columns in the nozzle channels so as to eject the droplets containing the objects through the nozzle orifices. In examples, the force applicator comprises a displaceable wall arranged on a side of the nozzle channels facing away from the nozzle orifices and an actuator configured to cause displacement of the displaceable wall so as to eject the droplets containing the objects through the nozzle orifices. In examples, the force applicator comprises a drive configured to apply an acceleration or a deceleration to the microfluidic device so as to generate an inertial momentum on the objects and the liquid columns to drive the liquid containing the objects out of the nozzle orifices. Using such force applicators, the fluidic acceleration in the liquid columns in the nozzle channels, by which the respective droplets containing the objects are ejected, may be generated concurrently and at the same level.

In examples of the present disclosure, the liquid suspension is supplied to the inlet of the at least one fluid channel using a pipette tip. In case of a plurality of fluid channels and associated inlets, the same or different liquid suspensions may be supplied by one pipette tip per fluid channel. The flow of the liquid suspension through the at least one fluid channel may be supported by the hydrostatic pressure of a liquid column inside the pipette tip or by active drive mechanisms such as liquid pumps or similar.

### BRIEF DESCRIPTION OF THE DRAWINGS

Embodiments of the present invention will be detailed subsequently referring to the appended drawings, in which:

FIGS. 1A and 1B show a schematic top view and cross-sectional view of a microfluidic device;

FIG. 2 shows a schematic cross-sectional view of a microfluidic device comprising a force applicator along with a receptacle plate;

FIG. 3 shows a schematic view of a microfluidic device inserted into a centrifuge;

FIG. 4 shows a schematic perspective view of an example of a microfluidic device comprising a micro-well plate holder;

FIG. 5. shows a schematic cross-sectional view of a detail of the microfluidic device of FIG. 4;

FIG. 6 shows a perspective view of an example of a micro-well plate;

FIG. 7 shows a schematic perspective view of an example of the microfluidic device of FIG. 4 with pipette tips and a micro-well pate;

FIG. 8 shows a schematic enlarged view of a detail of FIG. 7;

FIG. 9 shows a schematic cross-sectional view of an example of trapping sites with associated nozzle channels during cell trapping; and

FIG. 10 shows a schematic cross-sectional view of the trapping sites of FIG. 9 during cell transfer.

### DETAILED DESCRIPTION OF THE INVENTION

In the following, examples of the present disclosure will be described in detail using the accompanying drawings. It is to be pointed out that the same element or elements that have the same functionality are provided with the same or similar reference numbers, and that a repeated description of elements provided with the same or similar reference numbers is typically omitted. Hence, descriptions provided for elements having the same or similar reference numbers are mutually exchangeable. In the following description, a plurality of details is set forth to provide a more thorough explanation of examples of the disclosure. However, it will be apparent to one skilled it the art that other examples may be practiced without these specific details. In other instances, well-known structures and devices are shown in block diagram form rather than in detail in order to avoid obscuring examples described herein. In addition, features of the different examples described herein may be combined with each other, unless specifically noted otherwise.

The present disclosure solves the problem of isolating objects out of a suspension and transferring them into individual receptacles, for example the individual wells of a micro-well plate MWP, such that a controlled number of the objects, such as exactly one object, is placed into each receptacle. The term “object” as used herein should imply any kind of solid or soft object suspended in liquid, regardless of its size (as long as it may be handled using the microfluidic devices disclosed herein) or whether it is of biological nature or not. Examples of “objects” are single cells, cell cluster (such as spheroids, organoids and tumoroids) and particles. Examples relate to a microfluidic device which can be operated using conventional laboratory equipment, such as a pipette and a laboratory centrifuge. Examples relate to methods for operation of such a device.

The microfluidic device may be fabricated as a single use item by injection molding or similar low-cost fabrication technology to enable hygienic or even sterile operation. The isolation of objects and their transfer into the receptacles may be achieved by the microfluidic device in a highly parallel manner, such that for example 96, 384 or 1536 objects can be isolated and transferred at once. Thus, the present disclosure improves cell handling in terms of cost and throughput, while it provides a similar cell viability and single cell efficiency as the best methods currently available. Accordingly, examples of the present disclosure may be particularly suited for applications in which a high throughput of single cell isolation as well as high cell viability is desired, such as mono-clonal cell line development or in-vitro diagnostic applications making use of spheroids or tumoroids.

The term microfluidic device as used herein relates to devices including structures suited to process liquid volumes in the range of pico-liter to milli-liter. The fluidic structures of the microfluidic device may have dimensions appropriate to handle such liquid volumes.

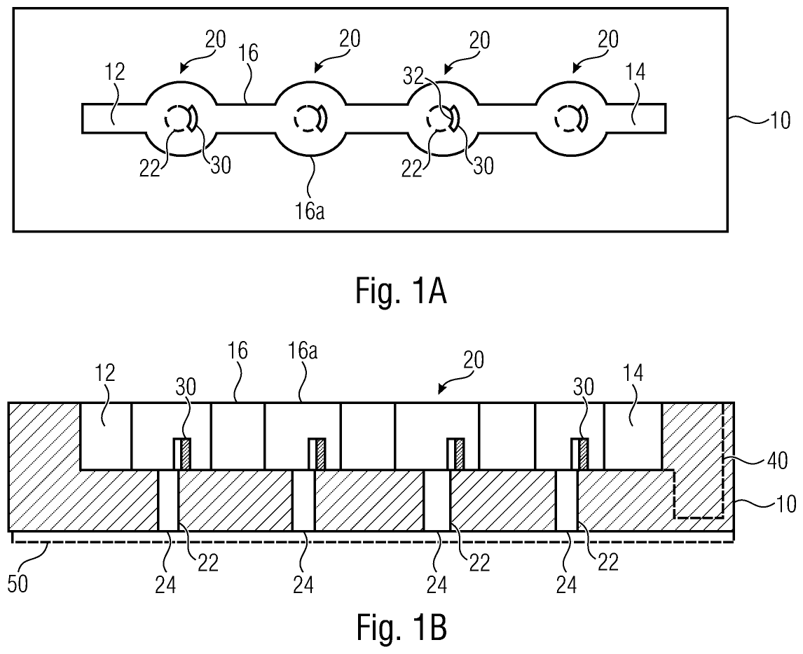

FIG. 1A shows a schematic top view of an example of a microfluidic device including a substrate 10, in which fluidic structures are formed. FIG. 1B shows a cross-sectional view thereof. The substrate 10 may be formed of a single layer or a plurality of layers. The substrate 10 may be formed of a polymer material or any other suitable material. The substrate 10 may comprise one or more layers. The fluidic structures comprise a fluid inlet 12, a fluid outlet 14 and a fluid channel 16 fluidically connecting the fluid inlet 12 to the fluid outlet 14. A plurality of passive microfluidic trapping sites 20 is arranged along the fluid channel 16. While a single fluid channel 16 and four trapping sites 20 are shown in FIG. 1 it goes without saying that other examples may include a different number of fluid channels and trapping sites. The microfluidic device comprises a plurality of nozzle channels 22, each associated with one of the trapping sites 20. To be more specific, each nozzle channel 22 is arranged in fluidic communication with the associated trapping site 20, so that an object, such as a single cell, trapped in the trapping site 20 is arranged at one end of the nozzle channel 22. In other words, each trapping site 20 comprises a nozzle channel 22. Each nozzle channel 22 comprises a nozzle orifice 24 at the other end thereof.

The opposing upper and lower surfaces of substrate 10 may be referred to as main surfaces of the microfluidic device as these surfaces are the largest surfaces of the microfluidic device. The fluid channel 16 extends in a direction parallel to the main surfaces. The nozzle channels 22 extend in directions perpendicular to the fluid channel 16 and the main surfaces. The fluid channel 16 has bulges 16a at the positions of the trapping sites 20.

In the example shown in FIGS. 1A and 1B, each passive microfluidic trapping site 20 comprises an obstacle 30 within a main flow path parallel to the fluid channel 16. Each obstacle 30 comprises a concave surface representing a recess 32. The size of the recess 32 is adapted to the size of the defined number of objects to be trapped, such as to the size of a single cell or to the size of a cell cluster or a specific particle. The fluid channel 16 and the passive microfluidic trapping sites 20 are configured to direct the objects flowing along the channel to each of the passive microfluidic trapping sites 20 as long as the corresponding trapping site 20 is not occupied by the defined number of objects and to direct the main flow path around the respective passive microfluidic trapping site when the trapping site is occupied by the defined number of objects. In the example shown, the main flow path is directed around the obstacle via bulges 16a if the defined number of objects is arranged in the corresponding trapping site. In examples, the obstacle may have a small hole, grid or web structure to hold back the objects, but to permit liquid to pass if not occupied by the defined number of objects. In such cases, the main liquid flow is directed towards the obstacle and objects are provided to the trapping site by hydrodynamic forces more efficiently than in the example shown in the figures. Therefore, such trapping sites are also referred to as passive hydrodynamic trapping sites. Due to the directed supply of objects to the trapping sites, hydrodynamic trapping sites can lead in average to a faster population of trapping sites as compared to general microfluidic trapping sites that do not exploit hydrodynamic forces to direct the objects into the trapping sites. In particular, hydrodynamic trapping sites can also operate in a space environment, while many microfluidic trapping technologies rely on gravity to trap the cells and thus could not function in space. In other examples, the trapping sites may be formed by any other type of passive microfluidic trapping site described herein and any other type of passive microfluidic trapping site known according to the state-of-the art suitable to trap a defined number of objects, such as a single cell, at an appropriate position.

In examples, a lid may be provided on the main surface of the substrate in which fluid channel 16 is formed. The lid may include an opening at the position of the fluid inlet 12 or forming the fluid inlet. In examples, a waste reservoir 40 may be formed in the substrate 10 as schematically shown in FIG. 1B in broken lines. The microfluidic device may comprise a seal 50 sealing the nozzle orifices 24 as shown in FIG. 1B in broken lines.

In operation, a liquid suspension containing the objects to be isolated is supplied to the inlet 12, such as by a pipette tip. The liquid suspension flows along the fluid channel 16. While the liquid suspension flows along the fluid channel, a defined number of objects is trapped at each passive hydrodynamic trapping site 20. Moreover, liquid columns are formed in the nozzle channels 22. Excessive liquid suspension may flow into the waste reservoir 40. During this operation, the nozzle orifices 24 may be sealed by the seal 50. Otherwise, leakage of liquid from nozzle orifices 24 may be prevented by surface tension at the lower end of the nozzle channels 22, i.e., by a meniscus formed at the nozzle orifices 24.

The microfluidic device may be placed on a receptacle plate, such as a micro-well plate after the above process of trapping or before that process. If the seal 50 is provided it is removed before placing the microfluidic device on the receptacle plate.

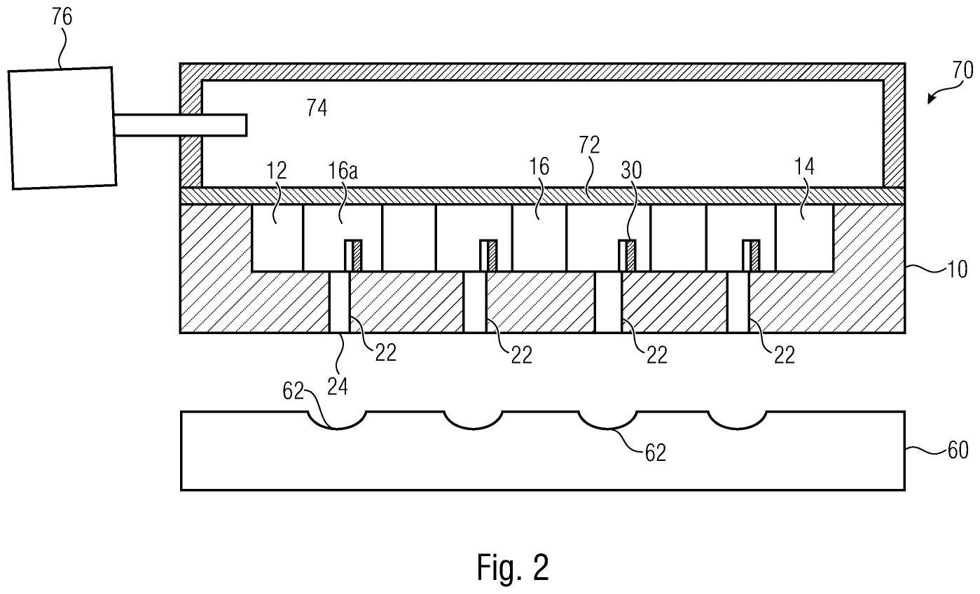

FIG. 2 shows the microfluidic device placed on a receptacle plate 60 comprising receptacles 62 such that the nozzle orifices 24 mate with the receptacles 62. It is not necessarily needed that a single nozzle mates with a single receptacle. In examples, two or more nozzles can be arranged in a way that they all mate with the same receptacle to deliver two or more objects to the receptacle. In such examples, the number of nozzles can be larger than the number of receptacles. FIG. 2 further shows a force applicator 70. In the example shown, force applicator 70 comprises a displaceable wall 72 arranged on the surface of substrate 10 in which the fluid channel 16 is formed. Force applicator 70 further comprises a pressure chamber 74 and a pressure generator 76 in fluid communication with pressure chamber 74 so as to generate overpressure in pressure chamber 74. Generating overpressure causes portions of the displaceable wall 72 to be displaced into the fluid structures formed in the surface of substrate 10 on which displaceable wall 72 is formed. Thus, force is applied concurrently to the liquid columns in the nozzle channels 22 and to the objects trapped in the trapping sites 20. Thereby, liquid acceleration is caused parallel to the nozzle channels and liquid droplets containing the objects are ejected from the nozzle orifices 24 into the receptacles 62. Thus, the objects are ejected into the receptacles in parallel.

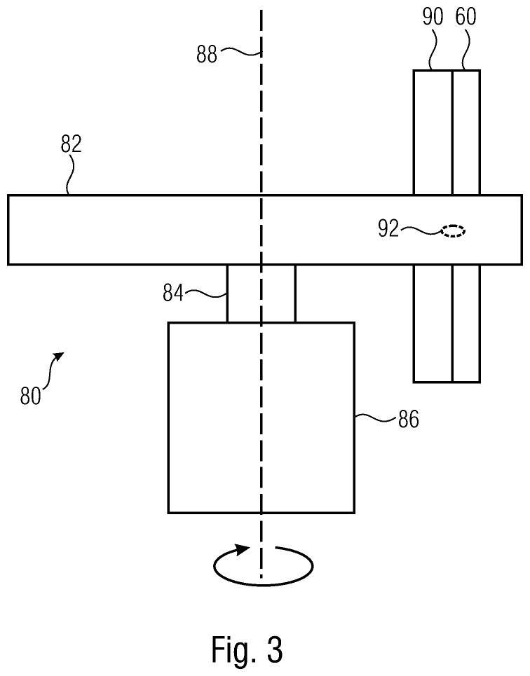

In other examples, the force applicator comprises a centrifuge to rotate the microfluidic device and the receptacle plate so that the liquid acceleration in the nozzle channels is caused by centrifugal force. FIG. 3 shows a centrifuge 80 comprising a rotor 82 supported by a shaft 84. The shaft 84 is rotatable by a motor 86 so that the rotor 82 is rotatable around an axis of rotation 88. Further schematically shown is an assembly of a microfluidic device 90 placed on top of a receptacle plate 60. Microfluidic device 90 is an example of any microfluidic device described herein. The assembly may be coupled to the rotor by a swing device (schematically shown in FIG. 3 by a swing axis 92) so that the assembly may swing from a horizontal loading orientation into a vertical orientation shown in FIG. 3 when rotor 82 rotates. In this orientation, the centrifugal force acts parallel to the nozzle channels so as to eject droplets containing the objects from the nozzle orifices into the receptacles. In other examples, the assembly may be inserted into the rotor in the vertical orientation so that a swing device is not required.

Examples of the present disclosure are based on the technology of microfluidic trapping of cells with subsequent ejection of the trapped objects through the adjacent nozzle channels. Examples of microfluidic cell trapping are described in [2] and U.S. Pat. No. 10,351,894 B2, which provide examples of specific trapping technologies. Passive microfluidic trapping makes use of microfluidic structures that generate a flow profile that supplies cells suspended in the liquid to a certain position in the channel referred to as “trapping site”. Once a trapping site is occupied by a specific object, such as a cell or a cell cluster, the flow field changes in passive trapping such that no other object can occupy the same trapping site. In active trapping, the flow field is changed actively by external mechanisms that are controlled by an operator or an automatic detection system, once a trapping site has been occupied Thus, the main difference between active and passive trapping is that active trapping involves additional technical means and energy in addition to the liquid flow that supplies the objects for trapping, while passive microfluidic trapping does not. In both cases, no other object will be guided to the same trapping site. Therefore, each trapping site is occupied by a single object, such as a single cell, only. This basic principle can be achieved by numerous different microfluidic designs and arrangements that are published. Microfluidic trapping of cells is thus a well-known technology according to the state of the art. Examples of the present disclosure make use of passive microfluidic cell trapping to isolate cells or cell clusters from a liquid suspension.

The drawback of some currently available microfluidic trapping devices is that the isolated objects cannot be transferred to individual receptacles that are not part of the microfluidic device, such as a MWP. Therefore, the cells are often analyzed inside the device and/or released as a bulk suspension to be collected as an ensemble of cells outside of the device. The present disclosure solves the problem of transferring trapped objects from a microfluidic trapping device having a multitude of trapping sites to a multitude of external receptacles simultaneously, while maintaining the isolation of the cells, such that a defined number of objects, such as exactly one object, is transferred from each trapping site of the microfluidic trapping device to each receptacle.

To achieve this performance, the microfluidic (trapping) device according to the present disclosure, which may be a microfluidic chip, has an opening, referred to herein as nozzle channel and nozzle orifice, associated with each passive hydrodynamic trapping site that is open or can be opened to the ambient and that is large enough so that the trapped objects can pass through. The fluidic design of the passive hydrodynamic trapping site can be of any type as known according to the state of the art or developed in the future. Reference is made to [2], for example, as far as an overview of examples is concerned.

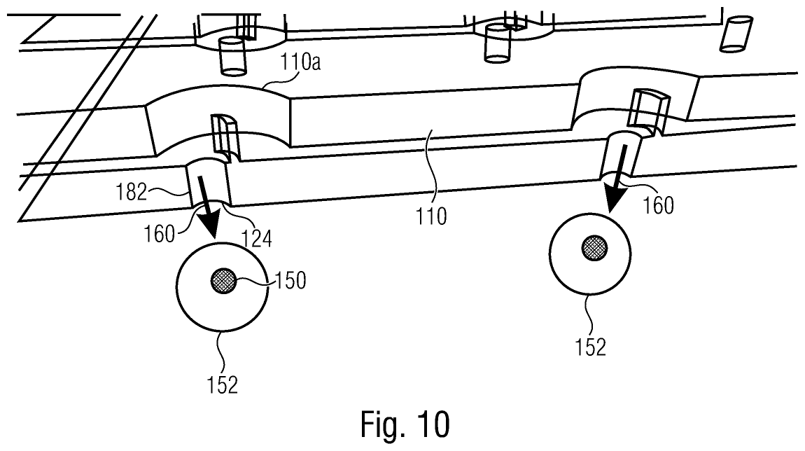

Passive microfluidic trapping sites are characterized by the fact that no external, energy consuming actuation mechanism (such as dielectrophoresis (DEP) or any other external means like additional hydrodynamic pressure, mechanical force, light etc.) is needed to force the objects into the trapping sites and/or to control the entry into the trap. Passive microfluidic trapping sites rely on forces that are present in the trapping chip or the environment, anyway. For example, gravity is often used to trap cells in micro wells. When they flow over a well with an appropriate size, gravity pulls the cells into the well, see FIG. 10 of [2], for example. Global external forces acting on the whole microfluidic device, like gravity, centrifugal forces, electrical forces or similar that act on the objects anywhere in the microfluidic device, may support the passive trapping. If the nozzle diameter and length is approximately equal to the diameter of the objects to be trapped, or at least not twice as large, only one object can enter into the nozzle and the nozzle itself can serve as a trapping site. Alternatively, surface forces that are exerted by biomolecules immobilized at the trapping sites can be used to capture cells (referred to as “affinity capture”) by the chemical interaction between an immobilized ligand and a targeted receptor on the cell surface, when the suspension liquid passes a patterned area including the trapping sites, see FIG. 1 of [8], for example. A very common method of passive trapping is to use the energy provided by the flow that is used to transport the objects along the fluid channel also for forcing them into the trapping sites, see again [2]. This is approach is referred to as hydrodynamic trapping as mentioned above. It does neither involve additional external energy nor environmental forces like gravity or the like. Hydrodynamic trapping works only by virtue of a certain hydrodynamic flow field—enabled by the design of the microfluidic structures forming the fluid channel and the trapping site—that guides the objects into the trap and changes significantly when a trap is occupied.

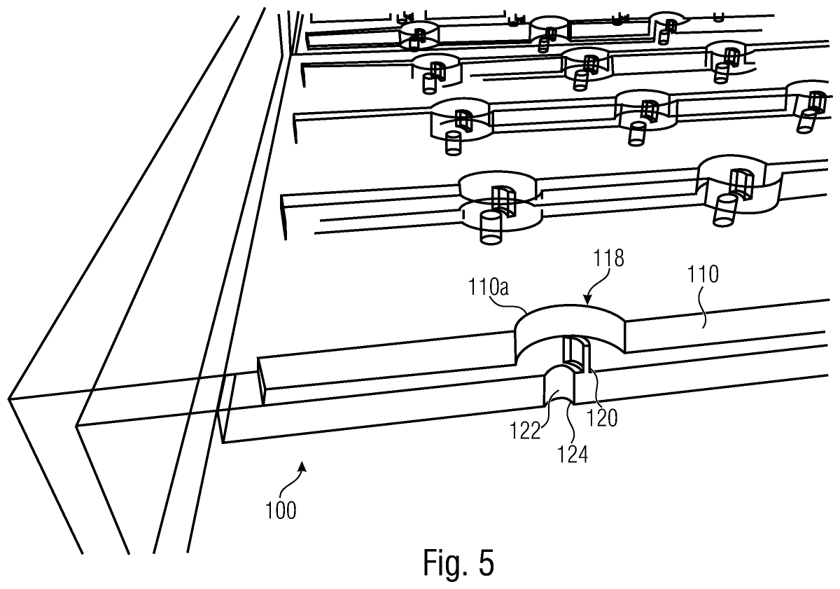

In examples, the passive microfluidic trapping sites are passive hydrodynamic trapping sites or traps, which are a special case of passive microfluidic traps that rely on hydrodynamic forces exerted by the transporting flow to efficiently direct the objects into the traps. The hydrodynamic trapping forces are generated by shaping the flow field in a specific way such that the main flow path is directed towards the trapping site as long as the trapping site is not occupied by an object or the defined number of objects. Once an object has been trapped, the flow field changes due to the presence of the object which presents an additional resistance to the flow when it is immobilized at the trapping site. Due to this additional resistance, the flow field changes and the main flow path is directed now around the trapping site while still maintaining a certain force on the trapped object to keep it at the trapping site. A large variety of different examples of such passive hydrodynamic traps are known according to the state of the art, see [2], FIGS. 5, 8 and 9, for example. In examples, the trapping sites in the present disclosure may be formed by such passive hydrodynamic traps as known in the art. The variation in the flow field before trapping and after trapping of an object is caused by channel walls and obstacles with a certain geometry that lead to the characteristic effect of a) a flow field that is directing the objects to the trapping site and b) a change of the flow field once the trapping site is occupied to direct the flow around the occupied trapping site and towards the next empty trap in most cases.

In examples, at least some of the passive microfluidic trapping sites may be configured to function according to the micro well trapping principle. In such examples, the nozzle channel may function as the trapping site without any additional obstacle. The nozzle channel may comprise cross-sectional dimensions (such as a diameter) and a length that are larger than the size of the object to be trapped, but smaller than two times the size of the object to be trapped. In operation, the object may be driven into the nozzle channel by gravity. In such examples, the obstacles 30 shown in FIGS. 1A, 1B and 2 may be omitted.

In examples, flow of the liquid suspension through the fluid channel is caused by a driving pressure acting on the liquid suspension supplied to the inlet. While the microfluidic trapping device is loaded with objects, i.e., the objects are isolated at the respective trapping sites, the driving pressure of the flow of the liquid suspension through the fluid channel at the trapping sites must not exceed the capillary pressure of the nozzle channels in case the nozzles orifices are not closed. Otherwise, the liquid might leak out of the nozzle orifices. This can be prevented by covering the nozzle orifices with a sealing to prevent liquid flow through the nozzle channel during the trapping process. Thus, the trapping can be accomplished with open nozzle orifices as well as with sealed nozzle orifices, depending on the magnitude of the driving pressure in relation to the capillary pressure in the nozzle channel.

In examples, the driving pressure can be established by hydrostatic pressure, slow centrifugation or any other suitable means. Once the trapping process is finished and each trapping site is occupied by an object or the defined number of objects, the flow is stopped, the seal on the nozzle orifices (if any) is removed and the microfluidic trapping device is placed onto the receptacles, such that each receptacle mates with a defined number of nozzle orifices, such as one nozzle orifice per receptacle, for example.

In order to transfer the objects into the receptacles a force causing a liquid acceleration may be applied essentially perpendicular to the microfluidic channel(s) connecting the individual trapping sites, i.e., essentially parallel to the nozzle channel, to eject liquid from each nozzle orifice containing the object into the corresponding receptacle. In examples, the actuation force can be established by centrifugation of the microfluidic trapping device located on top of the receptacles, such that the centrifugal force is directed from the nozzle orifices towards the receptacles. This is particularly advantageous when the objects are to be transferred into a MWP, because in this case existing MWP-centrifuges can be used for operation that are readily available in most laboratories. Alternatively, the force for accelerating the liquid inside the nozzles might be exerted by mechanical displacement of the outer surface of the microfluidic trapping chip. Alternatively, a drive for generating an inertial momentum of the liquid inside the nozzles by rapid deceleration (such as disclosed in DE 19 913 076 A1 for printing micro arrays) or rapid acceleration, or any other suitable means may be provided. With respect to the features of a drive configured to implement such an inertial momentum by acceleration or deceleration, reference is made to the teaching of DE 19 913 076 A1. Thus, in examples, a fluidic displacement may be applied to the nozzle channels, or the microfluidic device may be accelerated or decelerated in direction of the nozzle channels to generate an inertial force to the liquid columns and the objects. The amount of liquid transferred together with the individual objects depends on the magnitude and duration of the actuation force as well as on other parameters like for example the dimensions of the nozzle channel and whether the inlet and/or the outlet of the microfluidic trapping chip are sealed when applying the actuation force.

In other examples, transfer of the objects may be achieved in a different manner. In examples, the aliquots are not ejected as a free flying droplet. In examples, a hanging drop may be generated at the nozzle orifices which comes into contact with the bottom of the associated receptacle when reaching a specific size such that part of the liquid and the object are transferred to the receptacle. In other examples, the nozzle orifice may be brought into contact with another liquid so that the objects are ejected directly into the other liquid without forming a droplet.

The present disclosure does not rely on a specific type and design of the passive microfluidic trapping mechanism, nor on a specific drive mechanism to first isolate and then eject the objects from the nozzle orifice. It can work with any kind of corresponding microfluidic trapping mechanism and any kind of drive mechanism that is able to eject liquid out of the nozzles. Without losing this general concept, but just for the purpose of clarity, further examples of the device and method according to the present disclosure are described in the following. An example may have particularly advantageous features for transferring single cells into each well of a MWP.

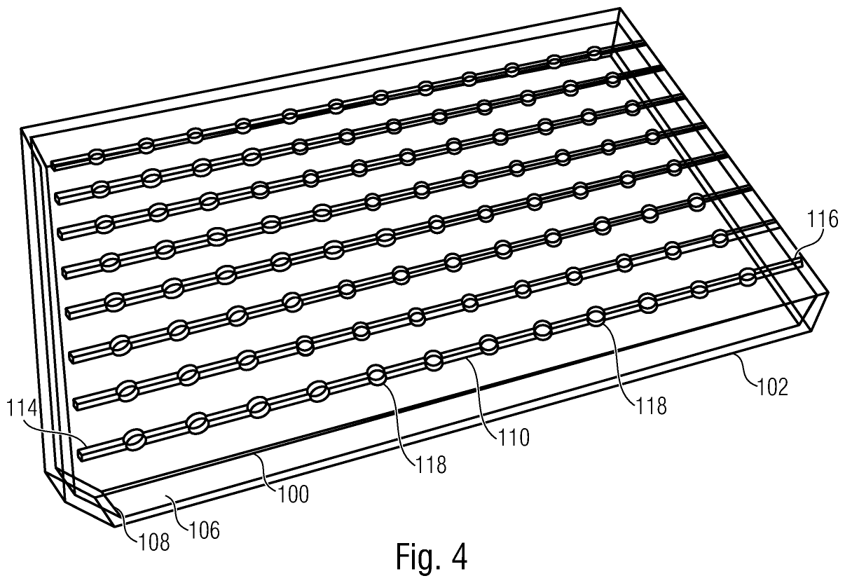

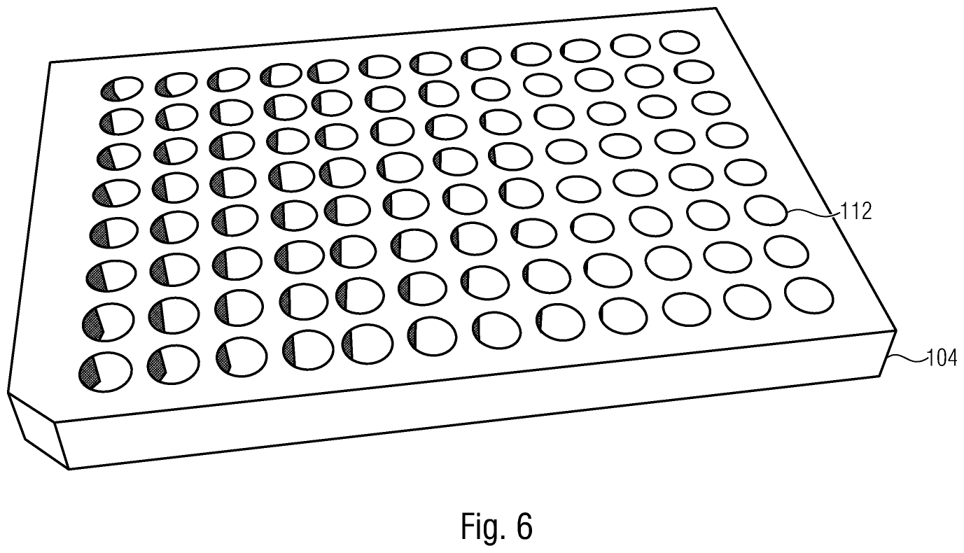

As shown in FIG. 4, an example of the microfluidic device of the present disclosure may comprise of a flat rectangular microfluidic chip 100. The microfluidic chip 100 may have the size of a MWP, for example approximately 80×120 mm, and a thickness of about 1 to 4 mm. The large faces will be referred to as main surfaces of the chip and, in particular, as “top” and “bottom” sides of the chip. The chip 100 may be made out of transparent plastic material. In the example shown, the chip 100 may be supported by a support 102. The support 102 and the chip 100 may be formed in one piece. The support 102 may be configured as a holder for a MWP, wherein an example of a MWP 104 as shown in FIG. 6. To be more specific, the support 102 comprises a cavity 106 under the chip 100, which is configured to accommodate the MWP 104. A feature, such as a slanted corner 108, may be provided to ensure that the MWP 104 is placed within the cavity 106 in the appropriate orientation.

The chip 100 comprises eight fluid channels 110 extending parallel to each other and parallel to the top and bottom sides of chip 100. The fluid channels 110 may be formed inside the chip 100 so that the top and bottom sides of the channels are closed. In examples, the fluid channels 100 may be formed in the top side of the chip 100 and may be covered by a lid (not shown). It is to be noted that the number of fluid channels may be different in other examples. The number of fluid channels 110 may correspond to the number of receptacles of the MWP in one direction, wherein, in the example shown, the MWP 104 comprises an array of eight receptacles 112 in one direction times twelve receptacles 112 in the other direction. Each fluid channel 110 connects a fluid inlet 114 with a fluid outlet 116 and, therefore, represents a microfluidic connection channel between the respective inlet 114 and outlet 116. A number of trapping sites 118 is arranged along each fluid channel 110. The number of trapping sites 118 may correspond to the number of the MWP in the other direction, i.e., twelve in the example shown. Of course, the number of trapping sides may be different in other examples.

FIG. 5 shows an enlarged view of a detail of the chip 100. As shown in FIG. 5, each trapping site 118 may comprise a bulge 110a of the corresponding fluid channel 110 and an obstacle 120 in the main flow path along the corresponding fluid channel 110. A nozzle channel 122 is formed below each trapping site 118. In other examples, the nozzle channel may form part of the trapping site. The nozzle channels 122 extend substantially perpendicular to the fluid channels 110. This may include nozzle channels 122 extending exactly perpendicular (90 degrees) to the fluid channels 110 and nozzle channels 122 extending in an angle of 85 to 95 degrees relative to the fluid channels 110. A lower end of the nozzle channels 122 forms a nozzle orifice 124 in the bottom side of the chip 100. The chip 100 may be formed of more than one layer, such as two layers, wherein the fluidic structures may be formed in the different layers. For example, the fluid channels 110 may be structured in a first layer and the nozzle channels 122 may be structured in a second layer. Obstacles 120 may be formed in or on the second layer.

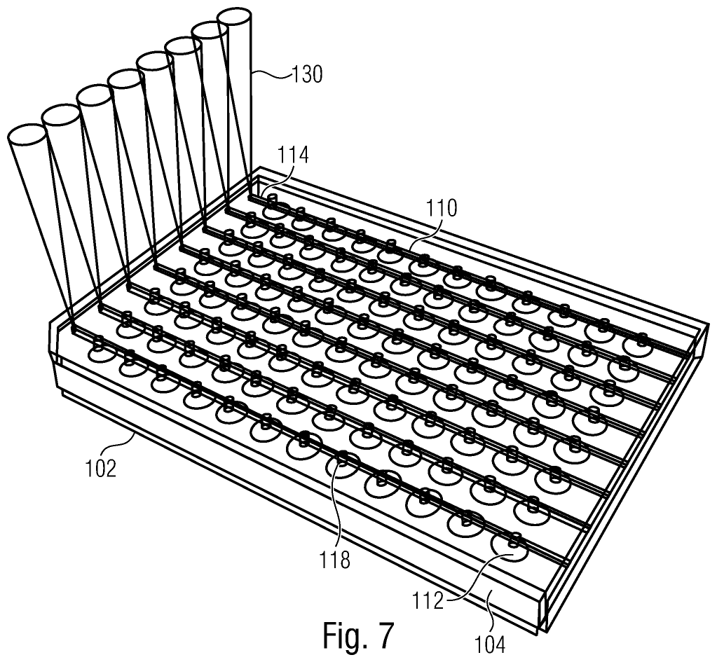

The inlets 114 and outlets 116 may be placed either on the top or bottom side or at the “edge” of the chip, which is any side that is not the top or bottom side, see FIG. 4. In examples, the inlets 114 are placed on the top side of the chip 100 to facilitate supply of liquid suspension into the fluid channels 110. There may be eight inlets 114 spaced 9 mm apart to accommodate the tips of an 8-channel manual pipette that may be used to fill the inlets 114. FIG. 7 shows eight pipette tips 130 of such a manual pipette arranged to fill the inlets 114. Pipette tips 130 may be disposable. The inlets 114 may be dimensioned such that the pipette tips 130 can be stuck into the inlets 114 to generate a fluidic reservoir with a tight connection to the chip and to achieve a certain hydrostatic height when the chip 100 is positioned upright with the inlets 114 facing up as shown in FIG. 7. In FIG. 4, the MWP 104 with the receptacles 112 is placed in the cavity 106 of the support 102 in such a manner that the receptacles 112 are aligned with the trapping sites 118. To be more specific, each nozzle orifice 124 is facing one of the receptacles.

From each inlet 114, one of the microfluidic connection channels 110 leads to the outlet 116 at the opposite side of the microfluidic chip 100. Along each microfluidic connection channel 110 in total twelve trapping sites 118 are arranged every 9 mm to match the layout of a standard 96-well MWP. At each trapping site 118, one of the nozzle channels 122 branches off the fluid channel 110. Thus, an array of 8×12 trapping sites is formed inside the chip. The nozzle channels 122 terminate on the bottom side of the chip 100 such that an array of 8×12 nozzle orifices at a pitch of 9 mm is formed. Depending on the objects to be isolated and transferred, the nozzle orifices 124 may have a circular shape and a size of 10 to 500 μm in diameter, see FIG. 5.

As explained above, there are various designs known according to the state of the art how to design efficient passive microfluidic trapping sites. For the example described here, the trapping sites 118 comprise a concave trapping structure 120 as sketched in FIGS. 5 and 6.

To make sure that objects are not leaving the nozzle channels 122 accidentally through the nozzle orifices 124 before the trapping operation is finished, the nozzle orifices 124 may might be sealed, such as by a self-adhesive tape seal for micro well plates or by pressing a rubber seal onto the bottom surface. If the nozzle orifices are not sealed, the lower boundary of the nozzle channel (and, therefore, the trap) will be formed by a liquid meniscus spanning across the nozzle orifice. This meniscus can hold back the objects as long as the driving pressure at each trapping site is not higher than the capillary pressure of the liquid meniscus inside the nozzle channel.

The operation of the microfluidic device according to the example described referring to FIGS. 4 to 7 is now explained.

A liquid suspension that contains objects, such as cells, cell clusters or particles, to be isolated is supplied to the inlets 114, such as by an 8-channel pipette a shown in FIG. 7. The disposable pipette tips 130 of the pipette may be filled up to a height of several mm or cm by aspirating with the pipette. The disposable tips are then stuck into the openings of the inlets 114, and the remainder of the pipette is removed, while the tips remain stuck in the inlets as shown in FIG. 7.

The flow rate to move the liquid suspension from the pipette tips 130 into the microfluidic chip 100 is provided by the hydrostatic pressure of the liquid columns inside the pipette tips 130 that slowly drives the liquid suspension from the pipette tips 130 into the microfluidic chip 100. This leads to a movement of the liquid along the microfluidic connection channels 110 and the trapping sites 118 so that each trapping site 118 is over time occupied by the defined number of objects, such as a single object.

After a certain time, the pipette tips 130 run empty and by then most of the liquid is discharged through the outlet, advantageously into some kind of waste container. In examples, a waste container may be integrated in the microfluidic chip 100. If sufficient objects were contained in the supplied liquid suspension, the trapping sites are meanwhile all occupied by single objects.

Optionally, after trapping the objects, the microfluidic connection channels 110 may be flushed to remove any remaining objects from the microfluidic connection channels 110, such as by adding some more clear liquid to the pipette tips.

If the nozzle orifices 124 were sealed before loading the liquid suspension, the seal is carefully removed after the trapping operation, before the microfluidic device is placed on top of a receptacle plate, such as a MWP.

The microfluidic device is then placed on top of the MWP. Placing the microfluidic device on top of the MWP may include placing the MWP 104 in the cavity 106 of the support 102. In other examples, the microfluidic device may be placed on the MWP as a lid of the MWP. In the example shown, by design, the 96 nozzles orifices 124 mate with the individual wells 112 of the MWP 104, such that each nozzle orifice 124 is located on top of the corresponding well 112 of the MWP 104.

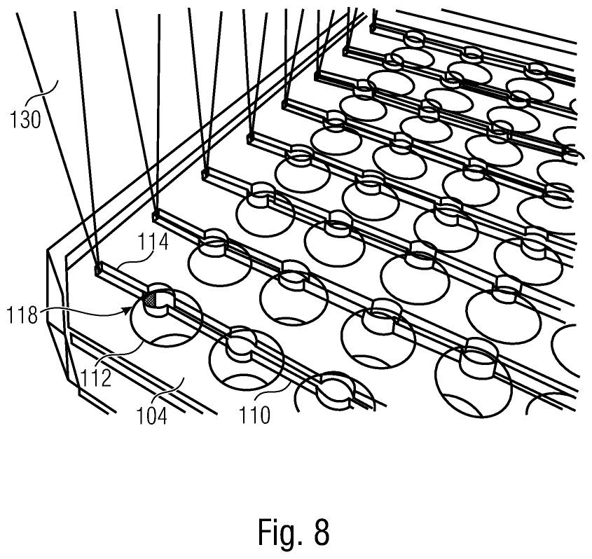

After or before placing the microfluidic device on top of the MWP, the pipette tips are removed. FIG. 8 shows an enlarged section of the arrangement of FIG. 7, wherein the pipette tips 130 are still stuck in the inlets 114 and the microfluidic device is already placed on top of the MWP 104.

In examples, the inlets 114 and/or outlets 116 may be sealed carefully by tape, stop cocks or plugs after the trapping operation to prevent venting of the fluid channels 110 during the further procedure.

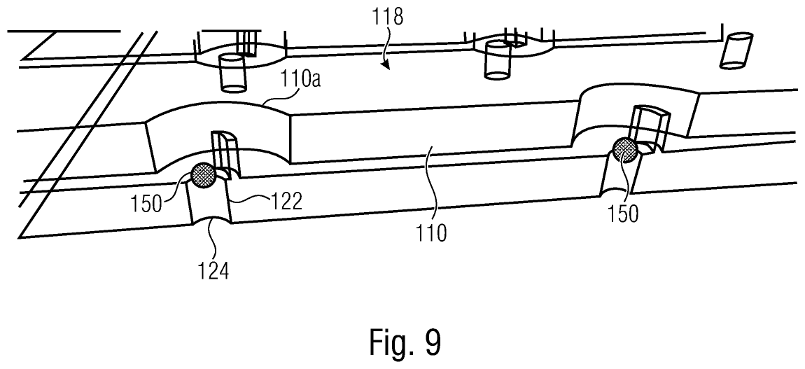

FIG. 9 shows a schematic enlarged view of two of the trapping sites 118 by which a respective object 150 is trapped. The trapping sites 118 are configured to trap the objects 150 such that the same are arranged at the end of the nozzle channel, which faces away from the nozzle orifice 124 or inside the nozzle channel.

The assembly of the microfluidic chip 100 and the MWP 104 is then placed carefully into a centrifuge for MWPs. In examples, the microfluidic chip is designed similarly to the lid of conventional MWP plates and comprises a rim that prevents the microfluidic chip from shifting or coming off the MWP. The assembly is then centrifuged for a short time at moderate frequency. The centrifuge may be a conventional centrifuge having a swinging rotor which makes sure that the exerted centrifugal force is directed at all times perpendicular towards the bottom of the microfluidic chip. Thus, the driving force that moves the liquid column confined inside the microfluidic nozzle channel out of the nozzle orifice is essentially parallel to the nozzle channel and essentially perpendicular to the microfluidic connection channel at all times. Thus, a liquid volume 152 containing the object 150 is ejected from each nozzle orifice 124. The liquid volume might be ejected as a free flying droplet that detaches from the nozzle orifice as shown in FIG. 10 or might be transferred by making physical contact to the receptacle or the liquid already contained therein without ever detaching from the nozzle orifice. In FIG. 10, arrows 160 indicate that the driving force for ejecting the liquid 152 is essentially parallel to the nozzle channels 122. The liquid volume 152 represents a liquid aliquot ejected from each of the nozzle orifices.

After the objects have been transferred to the MWP, the microfluidic chip can be discarded and the MWP containing the single objects, such as the single cells, can be further processed. For example, the transferred objects may be analyzed upon transfer into the MWP.

Examples of the present disclosure permit a fast and efficient isolation of suspended objects, such as cells, including a subsequent highly parallel transfer to external receptacles like e.g., the wells of a MWP. In examples, no expensive equipment for fluid control is needed as hydrostatic pressure provided by filled pipette tips or centrifugal force provided by conventional laboratory centrifuges can be used. Examples permit a transfer of single cells encapsulated in free flying droplets with high viability at low shear-force and without subjecting living cells to electrical fields. Thus, examples of the present disclosure permit a non-contact transfer of single objects from a microfluidic trapping chip into receptacles by simple standard laboratory equipment (e.g., centrifuge and pipette).

In examples, it is not necessary to monitor whether the defined number of objects, such as a single cell, is trapped as the trapping site is configured to trap the defined number of objects only. Nevertheless, examples provide the possibility of analyzing the trapped objects, e.g., by microscopy, for a considerable period of time inside the microfluidic chip, which may provide additional advantage for analysis and/or regulatory compliance purposes. Thus, examples permit an optional analysis and classification (e.g. by microscopic imaging) of trapped objects prior to transfer into receptacles.

Examples provide the possibility to observe the transfer of objects from the microfluidic chip to the receptacles through the top side of a transparent microfluidic chip by a camera, a high-speed camera or other sensors for regulatory compliance purposes. Thus, examples permit an observation of cells during ejection out of the nozzles and transfer into receptacle possible by specific imaging system, such as to prove mono-clonality of single cells.

Examples provide a trapping of objects inside the nozzle channel having no bottom, but instead a liquid meniscus that prevents discharging of trapped objects. Examples permit a highly parallel and simultaneous transfer of a multitude of different objects into a multitude of isolated receptacles within one run, if different inlets are supplied by different object types, such as different cell types. Examples permit an assembly of a controlled number of different objects into one receptacle, if nozzle orifices are arranged in such a pattern that the different objects supplied to different inlets are directed to the same receptacle.

Thus, examples provide a highly parallel single object isolation and transfer by a single use item, i.e., the microfluidic chip according to this disclosure. This enables hygienic or even sterile conditions that can be operated by conventional laboratory equipment like pipettes and centrifuges, without the need for any additional/expensive equipment.

According to a specific aspect, the present disclosure provides a microfluidic device having at least one inlet and one outlet that are in fluidic connection through at least one microfluidic connection channel that features a multitude of passive microfluidic trapping sites. Each trapping site is able to trap a defined number of cells, particles or objects from a liquid suspension flowing along the microfluidic connection channel without intervention of an operator or an automatic detection system. Each trapping site is in fluidic connection with a microfluidic nozzle channel that is essentially perpendicular to the microfluidic connection channel and that exposes a nozzle orifice at its other end from which liquid can be discharged into a receptacle. Examples provide a method for operation of a microfluidic device according to the specific aspect, comprising the following steps: supplying a liquid suspension that contains cells, particles or objects to the at least one inlet; applying a pressure or flow rate to the supplied liquid to move the liquid suspension along the at least one microfluidic connection channel; Wait until the trapping sites are occupied by the specific number of cells, particles or objects (and optionally flush the microfluidic channel with clear liquid to remove any remaining cells, particles or objects through the outlet); place the microfluidic device on top of the receptacles intended for receiving the isolated cells, particles or objects such that the nozzles mate with the corresponding receptacles; and apply a force to the liquid column inside the microfluidic nozzle channels that is essentially parallel to the nozzle channels by suitable means to eject a liquid aliquot containing the trapped cells, particles or objects.

Further developments of the device according to the specific aspect may include at least one of the following: a drive mechanism for effecting a liquid flow through the microfluidic connection channel and/or droplet ejection (hydrostatic, centrifugal, etc.); a specific design of the passive microfluidic trapping site (according to one or several of the presented examples from literature); the described spatial arrangement of the microfluidic connection channel, trapping sites and nozzles to mate with the receptacles of a MWP.

In examples, the microfluidic device comprises a multitude of passive microfluidic trapping sites according to the state of the art. The multitude of passive microfluidic trapping sites do not have to be of the same nature and do not have to be designed for the same size of objects. Thus, different objects of different sizes may be isolated using the same microfluidic device. The spatial arrangement of the trapping sites on the chip is not essential and may be adapted to any arrangement of receptacles. Examples may comprise a plurality of microfluidic connection channels connecting a plurality of inlets and outlets. Examples may comprise a plurality of multifluidic connection channels connecting a plurality of inlets to one outlet or connecting one inlet to a plurality of outlets. Other examples may comprise a single inlet, a single outlet and a single microfluidic channel connecting all trapping sites. In examples, the nozzle channel is perpendicular to the microfluidic connection channel and connects the trapping site with the nozzle orifice from which the object can be ejected. In examples, the force to eject the trapped objects simultaneously is essentially parallel to the nozzle channels, i.e., the main direction in which the force acts is parallel to the longitudinal extension (perpendicular to the cross-section) of the nozzle channel.

In examples, the microfluidic device may have a size and shape corresponding to the lid of a micro well plate. In examples, the microfluidic device may comprise 96, 384 or 1536 nozzle orifices arranged in an array corresponding to the arrangement of the wells of a micro well plate. In examples, the microfluidic device has at least one inlet on one side and the nozzle orifices on the opposite side. In examples, the microfluidic device has at least one inlet on one side and the nozzle orifices on the same side. In examples, the microfluidic device has at least one inlet on one side at the edge of the microfluidic device. In examples, the microfluidic device has an integrated waste reservoir to capture excess liquid flowing out of the outlet. In examples, the microfluidic device is made out of transparent polymer material. In examples, a receptacle plate is or may be firmly attached to the microfluidic device to form on single integrated unit. In examples, the microfluidic device is arranged relative to a receptacle plate in such a way that more than one single nozzle orifice mates with a receptacle.

In examples, the size of the trapping sites is adapted to trap a defined number of objects, such as just one or two objects, of a size in a range of 10 μm to 100 μm. In examples, the objects are cells or cell clusters, such as spheroids. The term size of the trapping sites refers to the inner dimensions of the structure in which the defined number of particles is trapped, such as the diameter and the length of the nozzle channel or the dimensions of the trapping recess in the obstacle. In examples, the size of the trapping size may be larger than the size of just one object to be trapped but less than twice the size of the object. In examples, the size of the trapping sites is in the range of 15 μm to 150 μm. In examples, the inner diameter of the nozzle channel is in a range of 15 μm and 150 μm. In examples, the aspect ratio (length/diameter) of the nozzle channel is in a range of 1:1 to 2:1.

The microfluidic device according to the present disclosure comprises passive microfluidic trapping sites rather than active trapping mechanisms. Active trapping mechanisms using dielectrophoresis are disclosed in [9]. The mechanism disclosed in [9] relies on an active control of the cells that are allowed to enter the trap and needs a microscope to confirm the presence of cells inside the trap. For practical applications, such a device is less suited, because it is complex, slow and needs operator control to trap the cells. This makes its use prohibitive for large numbers of trapping sites. For a large number of trapping sites and highly parallel isolation and transfer of single objects, such as single cells, passive microfluidic traps turned out to be substantially more advantageous. The operation of the active traps disclosed in [9] is based on a controllable barrier that prevents cells entering into the traps by DEP, and if this barrier is switched off, cells are sedimenting by gravity into the trap that acts also as nozzle for later cell transfer. This active trapping principle is significantly different from passive microfluidic traps used in the present disclosure. The actuation principle described in [9] to initiate the transfer from the trap to the receptacle (i.e., pneumatic actuation) would most likely not work for a larger number of trapping sites, if hydrodynamic traps would have been used. Certainly, the pneumatic actuation principle would fail for a larger array sizes, such as 8×12 nozzles or more, because the actuation pressure cannot be delivered equally to all trapping sites due to the fluidic resistance, capacitance and impedance caused by the connection channels and the passive microfluidic trapping sites. The transmission of the pressure from the inlet along the connection channel and through the trapping sites would lead to a delay of the pressure pulse and to a reduced pressure level at the most distant nozzles. The pneumatic drive system disclosed in [9] is thus not capable to provide an actuation pulse to all the nozzles simultaneously and at the same pressure level. Because the pressure is supplied between the inlet and the outlet of the connection channels, a reduced pressure level is experienced by the nozzles close to the outlet in contrast to the nozzles close to the inlet. Because all the nozzles are supplied from the same inlet a large crosstalk exists between all the nozzles. In a device with a larger number of nozzles (e.g., 12 or 24 along one channel) the fluidic resistance and inductivity of the connection channel and the crosstalk between the nozzles would lead to unequal volumes, different ejection times and possibly failure in ejection of the liquid from such nozzles that are too distant from the inlet, or if one of the nozzles runs dry. It is therefore not straightforward to replace the active trapping mechanism by passive microfluidic trapping and to scale the principle described in [9] to a larger number of nozzles. The device disclosed in [9] can work only because the number of nozzles is small and the connection channel is comparably short. Therefore, a significant improvement of examples of the present disclosure is to provide also an actuation method that can eject the droplets from the nozzles simultaneously and with the same pressure for all nozzles, even for a device with a large number of nozzles. In order to transfer the objects into the receptacles according to the present disclosure a fluidic acceleration (actuation force) is applied essentially perpendicular to the microfluidic channels connecting the individual trapping sites, i.e., essentially parallel to the nozzle channel to eject a liquid droplet from each nozzle orifice containing the object into the corresponding receptacle. In an embodiment, the acceleration can be established by centrifugation of the microfluidic trapping chip located on top of the receptacles, such that the centrifugal force is directed from the nozzle towards the receptacles. Such a liquid acceleration (actuation force) may be provided to each nozzle channel in parallel (i.e., concurrently and at the same level) using centrifugal force, using a displaceable wall displaceable toward the nozzle channels, or by generating an inertial momentum of the liquid inside the nozzles by rapid deceleration. Centrifugal force is particularly advantageous when the objects are to be transferred into a MWP, because in this case existing MWP-centrifuges can be used for operation that are readily available in most laboratories.

Although some aspects have been described as features in the context of an apparatus it is clear that such a description may also be regarded as a description of corresponding features of a method. Although some aspects have been described as features in the context of a method, it is clear that such a description may also be regarded as a description of corresponding features concerning the functionality of an apparatus.

In the foregoing Detailed Description, it can be seen that various features are grouped together in examples for the purpose of streamlining the disclosure. This method of disclosure is not to be interpreted as reflecting an intention that the claimed examples need more features than are expressly recited in each claim. Rather, as the following claims reflect, inventive subject matter may lie in less than all features of a single disclosed example. Thus, the following claims are hereby incorporated into the Detailed Description, where each claim may stand on its own as a separate example. While each claim may stand on its own as a separate example, it is to be noted that, although a dependent claim may refer in the claims to a specific combination with one or more other claims, other examples may also include a combination of the dependent claim with the subject matter of each other dependent claim or a combination of each feature with other dependent or independent claims. Such combinations are proposed herein unless it is stated that a specific combination is not intended. Furthermore, it is intended to include also features of a claim to any other independent claim even if this claim is not directly made dependent to the independent claim.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LITERATURE

[1] J. Riba, S. Zimmermann, P. Koltay, Technologies for Automated Single Cell Isolation In: Handbook of Single Cell Technologies 2018, Springer Nature, T. S. Santra, F.-G. Tseng, T. S. Santra, F.-G. Tseng, ISBN: 978-981-10-4857-9
[2] Luan, Q., Macaraniag, C., Zhou, J., & Papautsky, I. (2020). Microfluidic systems for hydrodynamic trapping of cells and clusters. Biomicrofluidics, 14(3), 031502.
[3] Birchler, A., Berger, M., Jaggin, V., Lopes, T., Etzrodt, M., Misun, P. M., . . . & Frey, O. (2016). Seamless combination of fluorescence-activated cell sorting and hanging-drop networks for individual handling and culturing of stem cells and microtissue spheroids. Analytical chemistry, 88(2), 1222-1229.
[4] L. Gutzweiler, S. Kartmann, K. Troendle, L. Benning, G. Finkenzeller, R. Zengerle, P. Koltay, B. Stark, S. Zimmermann, Large scale production and controlled deposition of single HUVEC spheroids for bioprinting applications, 2017 Biofabrication, Band: 9 (2)
[5] Mekhileri, N. V., Lim, K. S., Brown, G. C. J., Mutreja, I., Schon, B. S., Hooper, G. J., & Woodfield, T. B. F. (2018). Automated 3D bioassembly of micro-tissues for biofabrication of hybrid tissue engineered constructs. Biofabrication, 10(2), 024103.
[6] David K. Wood, David M. Weingeist, Sangeeta N. Bhatia, and Bevin P. Engelward, Single cell trapping and DNA damage analysis using microwell arrays, PNAS Jun. 1, 2010 107 (22) 10008-10013;
[7] Zhang, K., Gao, M., Chong, Z., Li, Y., Han, X., Chen, R., & Qin, L. (2016). Single-cell isolation by a modular single-cell pipette for RNA-sequencing. Lab on a Chip, 16(24), 4742-4748.
[8] Zhang, Y., Lyons, V., & Pappas, D. (2018). Fundamentals of affinity cell separations. Electrophoresis, 39(5-6), 732-741.
[9] Massimo Bocchi et. al., “Inverted open microwells for cell trapping, cell aggregate formation and parallel recovery of live cells, Lab Chip, 2012, 12, 3168-3176

1. A microfluidic device comprising:
at least one fluid inlet and at least one fluid outlet;
at least one fluid channel fluidically connecting the at least one fluid inlet to the at least one fluid outlet;
a plurality of passive microfluidic trapping sites arranged along the at least one fluid channel, each passive microfluidic trapping site configured to trap a defined number of objects from a liquid suspension flowing along the at least one fluid channel;
each trapping site comprising a nozzle channel in fluidic communication with an associated nozzle orifice.

2. The microfluidic device of claim 1, wherein the at least one fluid channel and the passive microfluidic trapping sites are configured to operate as passive hydrodynamic trapping sites by directing a main flow path towards an obstacle as long as the trapping site is not occupied by the defined number of objects and to direct the main flow path around the obstacle of the respective trapping site when the trapping site is occupied by the defined number of objects.

3. The microfluidic device of claim 2, wherein at least some of the passive microfluidic trapping sites comprise a trapping recess arranged in the main flow path, wherein the size of the trapping recess is adapted to the size of the defined number of objects.

4. The microfluidic device of claim 1, wherein at least some of the nozzle channels comprise cross-sectional dimensions and a length that are larger than the size of the object, but smaller than two times the size of the object to be trapped and are configured to trap the object.

5. The microfluidic device of claim 1, wherein the microfluidic device comprises a microfluidic chip comprising opposing first and second main surfaces, wherein the at least one fluid channel extends parallel to the first and second main surfaces, wherein the nozzle channel extends perpendicular to the at least one fluid channel, and, advantageously, perpendicular to the first and second main surfaces.

6. The microfluidic device of claim 1, comprising a plurality of fluid channels arranged in parallel to each other, wherein a plurality of hydrodynamic trapping sites with associated nozzle channels is arranged along each fluid channel, wherein the plurality of nozzle orifices is arranged in a two-dimensional array, the two-dimensional array advantageously corresponding to the arrangement of wells of a micro-well plate.

7. The microfluidic device of claim 5 adapted to be placed as a lid on the micro-well plate or comprising a holder adapted to hold a micro-well plate.

8. The microfluidic device of claim 1, comprising a removable seal covering the nozzle orifices.

9. The microfluidic device of claim 1, wherein the fluid outlet leads into a waste reservoir formed in the microfluidic device.

10. The microfluidic device of claim 1, comprising a force applicator configured to apply a force to objects trapped in the passive hydrodynamic trapping sites and liquid columns in the nozzle channels concurrently and at the same level, so as to eject liquid aliquots comprising the objects through the nozzle orifices simultaneously.

11. The microfluidic device of claim 9, wherein the force applicator comprises either:
a centrifuge configured to apply a centrifugal force to the objects and the liquid columns so as to eject the liquid droplets comprising the objects through the nozzle orifices,
a displaceable wall arranged on a side of the nozzle channels facing away from the nozzle orifices and an actuator configured to cause displacement of the displaceable wall so as to eject liquid droplets comprising the objects through the nozzle orifices, or
a drive configured to apply an acceleration or deceleration to the microfluidic device so as to generate an inertial moment of the objects and the liquid columns to drive the droplets comprising the objects out of the nozzle orifices.

12. A method for operating a microfluidic device according to claim 1, comprising:
effecting a flow of a liquid suspension that comprises the objects from the at least one fluid inlet through the at least one fluid channel, wherein the trapping sites are occupied by the defined number of objects and liquid columns are formed in the nozzle channels;
placing the microfluidic device on a receptacle plate comprising a plurality of receptacles so that the nozzle orifices mate with the receptacles; and
concurrently applying a force to the trapped objects and the liquid columns in the nozzle channels so that a liquid aliquot comprising the defined number of objects is ejected from each nozzle orifice.

13. The method of claim 12, wherein applying a force to the trapped objects and the liquid columns in the nozzle channels comprises rotating the microfluidic device and the receptacle plate to apply a centrifugal force to the liquid columns and the objects, or displacing a displaceable wall arranged on a side of the nozzle channels facing away from the nozzle orifices to apply a fluidic displacement to the nozzle channels, or accelerating and decelerating the microfluidic device in direction of the nozzle channels to generate an inertial force to the liquid columns and the objects.

14. The method of claim 12, comprising supplying the liquid suspension to the at least one fluid channel using one pipette tip per fluid channel, wherein the flow of the liquid suspension through the at least one fluid channel is supported by the hydrostatic pressure of a liquid column inside the pipette tip.

15. The method of claim 12, comprising removing a seal covering the nozzle orifices before placing the microfluidic device on the receptacle plate.
